(19) United States
(12) Patent Application Publication
(10) Pub. No.: US 2023/0361672 A1
(43) Pub. Date: Nov. 9, 2023

(54) POWER SUPPLY SEMICONDUCTOR DEVICE AND SWITCHED CAPACITOR CONVERTER

(71) Applicant: ROHM Co., LTD., Kyoto (JP)

(72) Inventor: Isao Takobe, Kyoto (JP)

(21) Appl. No.: 18/312,777

(22) Filed: May 5, 2023

(30) Foreign Application Priority Data
May 9, 2022 (JP) 2022-077200

(51) Int. Cl. H02M 3/07; H02M 3/158

(52) U.S. Cl. CPC H02M 3/07; H02M 3/158

(57) ABSTRACT

Disclosed herein is a power supply semiconductor device used in a switched capacitor converter including a plurality of switch elements and a plurality of capacitors, the switched capacitor converter configured to turn on and off the plurality of switch elements according to a predetermined pattern to generate an output voltage from an input voltage. The power supply semiconductor device including a control drive circuit configured to generate a control signal for designating ON or OFF of each of the switch elements and turn on or off each of the switch elements according to the control signal. The plurality of switch elements include a first switch element group in which ON and OFF are controlled according to the control signal, and a second switch element group in which ON and OFF are controlled according to a signal with a phase shifted by 180 degrees from a phase of the control signal.

### CROSS REFERENCE TO RELATED APPLICATIONS

This US application claims priority benefit of Japanese Patent Application No. JP 2022-077200 filed in the Japan Patent Office on May 9, 2022. Each of the above-referenced applications is hereby incorporated herein by reference in its entirety.

### BACKGROUND

The present disclosure relates to a power supply semiconductor device and a switched capacitor converter.

There is a switched capacitor converter as a type of power supply apparatus. The switched capacitor converter includes a plurality of power transistors and a plurality of capacitors, and the switched capacitor converter switches the plurality of power transistors to generate an output voltage from an input voltage.

An example of the related art is disclosed in Japanese Patent Laid-open No. 2006-60939.

### BRIEF DESCRIPTION OF THE DRAWINGS

FIG. 1 is a circuit diagram of a power supply apparatus (switched capacitor converter) according to an embodiment of the present disclosure;

FIG. 2 is a circuit diagram of the power supply apparatus (switched capacitor converter) according to the embodiment of the present disclosure;

FIG. 3 is a schematic block diagram of the power supply apparatus according to the embodiment of the present disclosure;

FIG. 4 is an external perspective view of a power supply integrated circuit (IC) according to the embodiment of the present disclosure;

FIG. 5 is an external perspective view of the power supply IC according to the embodiment of the present disclosure;

FIG. 6 is a schematic block diagram of the power supply IC according to the embodiment of the present disclosure;

FIG. 7 depicts a connection relation between the power supply IC and a plurality of capacitors according to the embodiment of the present disclosure;

FIG. 8 depicts a relation between a drive voltage generation block and the plurality of capacitors according to the embodiment of the present disclosure;

FIG. 9 is a timing chart of basic switching control that can be executed by the power supply IC according to the embodiment of the present disclosure;

FIG. 10 depicts the state of each switch element in a period (P1) in the basic switching control according to the embodiment of the present disclosure;

FIG. 11 depicts the state of each switch element in another period (P2) in the basic switching control according to the embodiment of the present disclosure;

FIG. 12 depicts waveforms of terminal voltages in the basic switching control according to the embodiment of the present disclosure;

FIG. 13 depicts waveforms of terminal voltages in the basic switching control according to the embodiment of the present disclosure;

FIG. 14 is a diagram for describing a flow of current in the basic switching control according to the embodiment of the present disclosure;

FIG. 15 is a signal waveform diagram in the basic switching control according to the embodiment of the present disclosure;

FIG. 16 is a timing chart of revised switching control that can be executed by the power supply IC according to the embodiment of the present disclosure;

FIG. 17 is a circuit diagram of a part particularly related to the operation of the revised switching control according to the embodiment of the present disclosure;

FIG. 18 is a signal waveform diagram in the revised switching control according to the embodiment of the present disclosure;

FIG. 19 is a diagram for describing a flow of current in the revised switching control according to the embodiment of the present disclosure; and

FIG. 20 depicts that a detection circuit is provided on a control drive circuit according to the embodiment of the present disclosure.

### DETAILED DESCRIPTION

An example of an embodiment of the present disclosure will now be specifically described with reference to the drawings. The same reference signs are provided to the same parts in the referenced drawings, and the description related to the same parts will not be basically repeated. In the present specification, symbols or reference signs for referencing information, signals, physical quantities, functional units, circuits, elements, or parts may be provided in order to omit or abbreviate the names of the information, the signals, the physical quantities, the functional units, the circuits, the elements, or the parts corresponding to the symbols or the reference signs, for the simplification of the description.

First, some terms used in the description of the embodiment of the present disclosure will be explained. An IC is an abbreviation for an integrated circuit. A ground denotes a reference conductive portion with a potential of 0 V (zero volt) as a reference or denotes the potential of 0 V. A conductor such as metal may be used to form the reference conductive portion. The potential of 0 V will be referred to as a ground potential in some cases. In the embodiment of the present disclosure, a voltage indicated without particularly providing a reference represents a potential with respect to the ground.

A level denotes a level of the potential, and the potential of a high level regarding a freely selected target signal or voltage is higher than the potential of a low level. A freely selected target signal or voltage in a high level technically means that the level of the signal or the voltage is in the high level, and a signal or a voltage in a low level technically means that the level of the signal or the voltage is in the low level. The level regarding the signal will be expressed as a signal level in some cases, and the level regarding the voltage will be expressed as a voltage level in some cases.

A switch from the low level to the high level in a freely selected target signal or voltage will be referred to as an up edge, and the timing of the switch from the low level to the high level will be referred to as up edge timing. The term “up edge” may be replaced with a term “rising edge.” Similarly, a switch from the high level to the low level in a freely selected target signal or voltage will be referred to as a down edge, and the timing of the switch from the high level to the low level will be referred to as down edge timing. The term “down edge” may be replaced with a term “falling edge.”

An on-state of a freely selected transistor provided as a FET (field-effect transistor) including a MOSFET denotes a state in which the drain and the source of the transistor are electrically connected, and an off-state denotes a state (cut-off state) in which the drain and the source of the transistor are not electrically connected. Similar is true for a transistor not classified as a FET. The MOSFET is an enhancement MOSFET unless otherwise stated. The MOSFET is an abbreviation for a “metal-oxide-semiconductor field-effect transistor.” It can be considered that the back gate is short-circuited to the source in a freely selected MOSFET unless otherwise stated.

An example of electrical characteristics of the MOSFET includes a gate threshold voltage. In a freely selected transistor that is an N-channel enhancement MOSFET, the transistor is in the on-state when the gate potential of the transistor is higher than the source potential of the transistor and the magnitude of the gate-source voltage of the transistor is equal to or greater than the gate threshold voltage of the transistor. The transistor is in the off-state otherwise. In a freely selected transistor that is a P-channel enhancement MOSFET, the transistor is in the on-state when the gate potential of the transistor is lower than the source potential of the transistor and the magnitude of the gate-source voltage of the transistor is equal to or greater than the gate threshold voltage of the transistor. The transistor is in the off-state otherwise. The gate threshold voltage of a freely selected FET is defined as a gate-source voltage necessary for applying a drain current of predetermined magnitude when a predetermined voltage is applied between the drain and the source of the FET under a predetermined ambient temperature environment. The gate-source voltage corresponds to the gate potential with respect to the source potential.

The on-state and the off-state of a freely selected transistor will simply be expressed as “ON” and “OFF” in some cases. A switch from the off-state to the on-state of a freely selected transistor will be expressed as “turn on,” and a switch from the on-state to the off-state will be expressed as “turn off.”

For a freely selected signal with the signal level in the high level or the low level, a period in which the level of the signal is the high level will be referred to as a high level period, and a period in which the level of the signal is the low level will be referred to as a low level period. Similar is true for a freely selected voltage with the voltage level in the high level or the low level.

It can be understood that the connection between a plurality of sections forming a circuit, such as freely selected circuit elements, wires (lines), and nodes, is electrical connection unless otherwise stated.

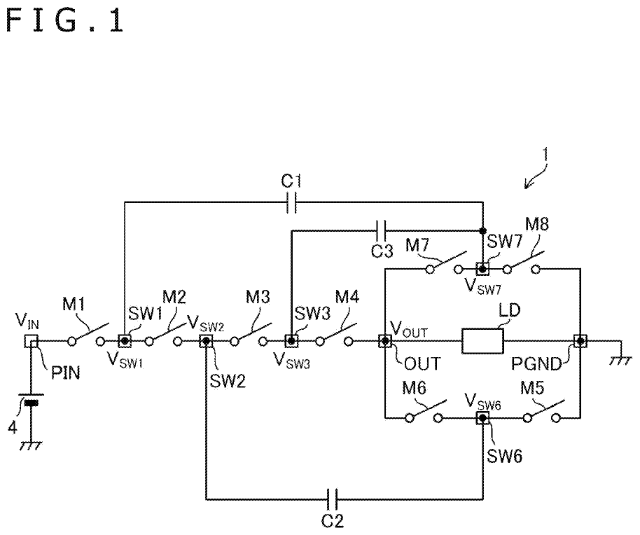

FIG. 1 illustrates a circuit diagram of a power supply apparatus 1 according to the embodiment of the present disclosure. The power supply apparatus 1 is a switched capacitor converter (hereinafter, referred to as SCC). Therefore, the power supply apparatus 1 will be referred to as SCC 1.

Main constituent parts of the SCC 1 include switch elements M1 to M8 and capacitors C1 to C3 that are flying capacitors. A voltage source 4 is connected to the SCC 1. The voltage source 4 generates a direct-current (DC) voltage with a predetermined positive DC voltage value and supplies the DC voltage as an input voltage V_{IN} to the SCC 1. A load LD of the SCC 1 is also illustrated in FIG. 1. The load LD is a freely selected load connected to the SCC 1.

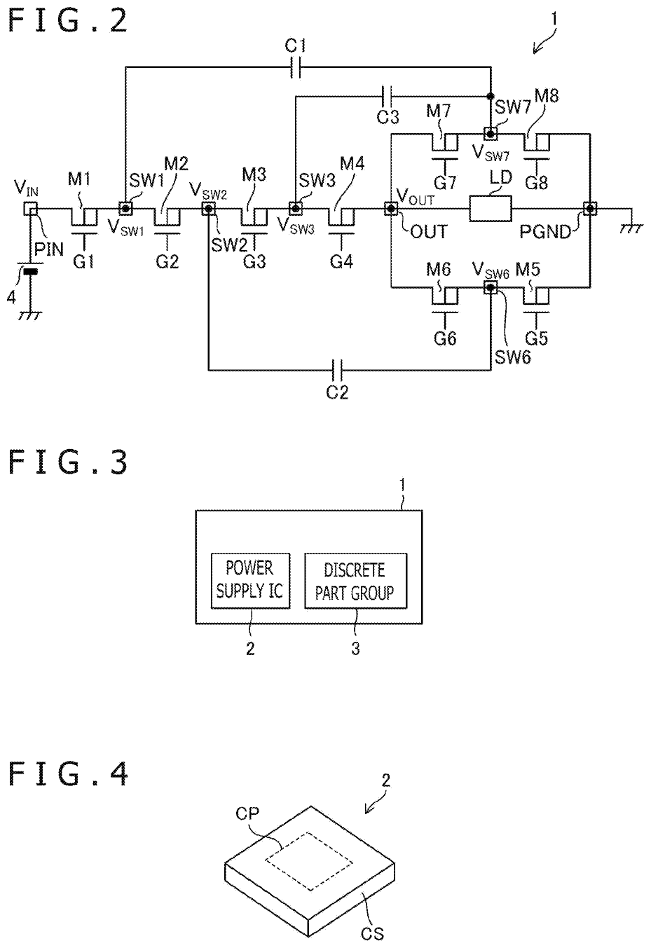

As illustrated in FIG. 2, the switch elements M1 to M8 include power transistors. Therefore, the parts M1 to M8 may be referred to as switch elements M1 to M8 or may be referred to as power transistors M1 to M8. Each of the power transistors M1 to M8 includes an N-channel MOSFET. One end of the switch element M1 corresponds to the drain of the power transistor M1, and the other end of the switch element M1 corresponds to the source of the power transistor M1. Similarly, one end of the switch element M2 corresponds to the drain of the power transistor M2, and the other end of the switch element M2 corresponds to the source of the power transistor M2. Similar is true for the switch elements M3 to M8.

A terminal PIN is an input terminal (voltage input terminal), and the terminal PIN receives the input voltage V_{IN}. A terminal OUT is an output terminal (voltage output terminal), and an output voltage V_{OUT} is applied to the terminal OUT. The output voltage V_{OUT} is an output voltage of the SCC 1. Voltages applied to terminals SW1, SW2, SW3, SW6, and SW7 will be referred to as voltages V_{SW1}, V_{SW2}, V_{SW3}, V_{SW6}, and V_{SW7}, respectively. A switching circuit including the power transistors M1 to M8 and the capacitors C1 to C3 is connected to the terminals PIN and OUT, and the power transistors M1 to M8 and the capacitors C1 to C3 are connected to each other such that the output voltage V_{OUT} is generated from the input voltage V_{IN} when the power transistors M1 to M8 are turned on and off according to a predetermined pattern.

Specifically, the drain of the power transistor M1 is connected to the terminal PIN. The terminal PIN is connected to the positive-side output terminal of the voltage source 4, and the terminal PIN receives the input voltage V_{IN} from the voltage source 4. Therefore, the input voltage V_{IN} is applied to the drain of the power transistor M1. The source of the power transistor M1, the drain of the power transistor M2, and a first end of the capacitor C1 are commonly connected to the terminal SW1. A second end of the capacitor C1, the source of the power transistor M7, and the drain of the power transistor M8 are commonly connected to the terminal SW7. The source of the power transistor M2, the drain of the power transistor M3, and a first end of the capacitor C2 are commonly connected to the terminal SW2. A second end of the capacitor C2, the source of the power transistor M6, and the drain of the power transistor M5 are commonly connected to the terminal SW6. The source of the power transistor M3, the drain of the power transistor M4, and a first end of the capacitor C3 are commonly connected to the terminal SW3. A second end of the capacitor C3 is connected to the terminal SW7. The source of the power transistor M4 and the drains of the power transistors M6 and M7 are commonly connected to the terminal OUT. The sources of the power transistors M5 and M8 are commonly connected to a terminal PGND. The terminal PGND is connected to the ground. One end of the load LD is connected to the terminal OUT, and the other end of the load LD is connected to the terminal PGND.

Therefore, the power transistor M1 is turned on or off to electrically connect or cut off the terminals PIN and SW1. The power transistor M2 is turned on or off to electrically connect or cut off the terminals SW1 and SW2. The power transistor M3 is turned on or off to electrically connect or cut off the terminals SW2 and SW3. The power transistor M4 is turned on or off to electrically connect or cut off the terminals SW3 and OUT. The power transistor M5 is turned on or off to electrically connect or cut off the terminals SW6 and PGND. The power transistor M6 is turned on or off to electrically connect or cut off the terminals OUT and SW6. The power transistor M7 is turned on or off to electrically connect or cut off the terminals OUT and SW7. The power transistor M8 is turned on or off to electrically connect or cut off the terminals SW7 and PGND.

It is assumed here that the SCC 1 functions as a voltage divider. Specifically, the output voltage V_{OUT} is a voltage ¼ times the input voltage V_{IN} in the SCC 1 of FIGS. 1 and 2. The value of the input voltage V_{IN} may be freely selected. To specifically describe the voltage, it is assumed here that the input voltage V_{IN} is 48 V. Therefore, the output voltage V_{OUT} is 12 V when the operation of the SCC 1 is stable. Signals applied to the gates of the power transistors M1 to M8 will be referred to as gate signals, and the gate signals of the power transistors M1 to M8 will be referred to as gate signals G1 to G8, respectively.

FIG. 3 is a schematic configuration block diagram of the SCC 1. The SCC 1 includes a power supply IC 2 that is a power supply semiconductor device, and a discrete part group 3 including a plurality of discrete parts externally connected to the power supply IC 2. The capacitors C1 to C3 are included in the discrete part group 3. The power supply IC 2 turns on and off the power transistors M1 to M8 according to a predetermined pattern to generate the output voltage V_{OUT} from the input voltage V_{IN}. The power transistors M1 and M8 are built in the power supply IC 2. Here, the SCC 1 may be modified such that the power transistors M1 to M8 are included in the discrete part group 3.

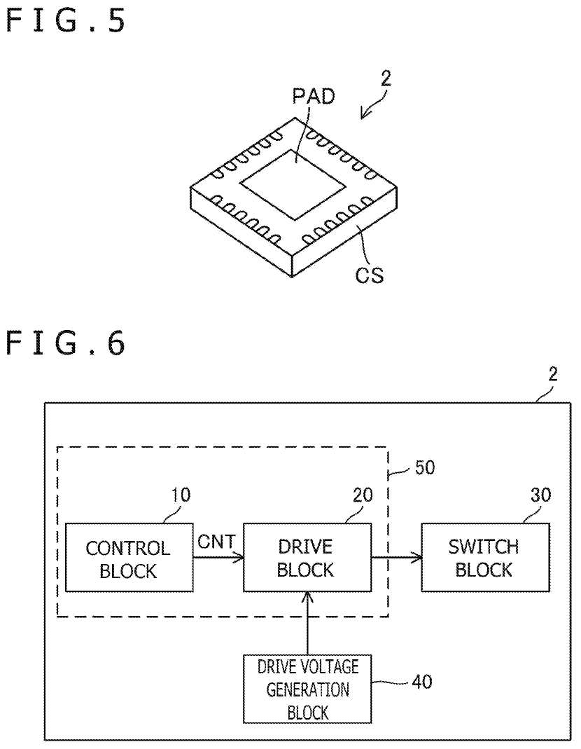

FIGS. 4 and 5 illustrate external perspective views of the power supply IC 2. The power supply IC 2 is an electronic part including a semiconductor chip CP including a semiconductor integrated circuit formed on a semiconductor substrate, a casing CS (package) that houses the semiconductor chip CP, and a plurality of external terminals exposed from the casing CS to the outside the power supply IC 2. The power supply IC 2 is formed by enclosing the semiconductor chip CP in the casing CS including resin. FIG. 4 is an external perspective view of the power supply IC 2 when the power supply IC 2 is observed from the front side of the casing CS of the power supply IC 2. FIG. 5 is an external perspective view of the power supply IC 2 when the power supply IC 2 is observed from the back side of the casing CS of the power supply IC 2. Only FIG. 4 of FIGS. 4 and 5 illustrates a dashed line to depict the schematic shape of the semiconductor chip CP. A metal pad PAD for releasing heat is provided on the back surface of the casing CS. The terminals PIN, OUT, PGND, SW1, SW2, SW3, SW6, and SW7 illustrated in FIGS. 1 and 2 are external terminals provided on the power supply IC 2.

Note that the type of the casing of the power supply IC 2 and the shapes and the number of external terminals of the power supply IC 2 illustrated in FIGS. 4 and 5 are illustrative only, and they can be optionally designed.

FIG. 6 illustrates a schematic internal block diagram of the power supply IC 2. The power supply IC 2 includes a control block 10, a drive block 20, a switch block 30, and a drive voltage generation block 40. The switch block 30 includes the power transistors M1 to M8. A circuit provided on the power supply IC 2 and including the control block 10 and the drive block 20 will be referred to as a control drive circuit 50. The control block 10, the drive block 20, the switch block 30, and the drive voltage generation block 40 are provided on the semiconductor chip CP in a form of a semiconductor integrated circuit, and therefore, the control drive circuit 50 is also provided on the semiconductor chip CP in a form of a semiconductor integrated circuit.

The control block 10 generates control signals CNT for designating ON and OFF of the power transistors M1 to M8 and outputs the generated control signals CNT to the drive block 20. The drive block 20 is connected to the gates of the power transistors M1 to M8, and the drive block 20 drives the gates of the power transistors M1 to M8 according to the control signals CNT to turn on or off the power transistors M1 to M8. That is, the drive block 20 generates and outputs the gate signals G1 to G8 according to the control signals CNT to thereby individually put the states of the power transistors M1 to M8 into the on-state or the off-state as designated by the control signals CNT. The drive voltage generation block 40 generates drive voltages that are voltages for driving the power transistors M1 to M8. The drive block 20 uses the drive voltages to individually put the states of the power transistors M1 to M8 into the on-state or the off-state.

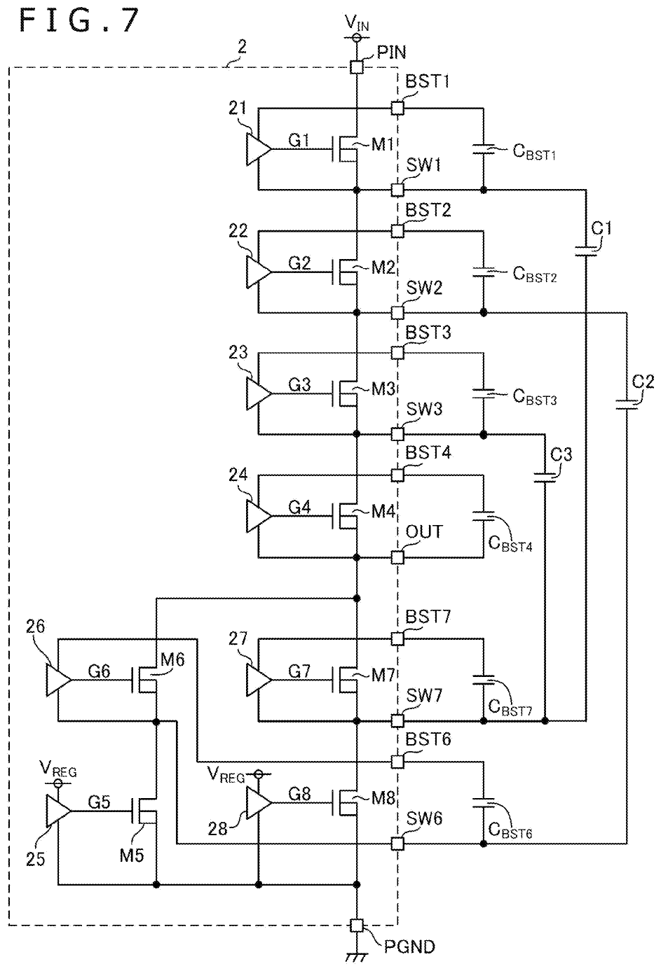

Gate drivers 21 to 28 illustrated in FIG. 7 are provided on the drive block 20. Terminals BST1 to BST4, BST6, and BST7 illustrated in FIG. 7 are external terminals provided on the power supply IC 2. In FIG. 7, capacitors CBST1 to CBST4, CBST6, and CBST7 are bootstrap capacitors included in the discrete part group 3.

First ends of the capacitors CBST1 to CBST4, CBST6, and CBST7 are connected to the terminals BST1 to BST4, BST6, and BST7, respectively, outside the power supply IC 2. Second ends of the capacitors CBST1 to CBST3, CBST6, and CBST7 are connected to the terminals SW1 to SW3, SW6, and SW7, respectively, outside the power supply IC 2, and a second end of the capacitor CBST4 is connected to the terminal OUT. The capacitors C1 to C3 that are flying capacitors are also provided outside the power supply IC 2, and the capacitor C1 is connected to the terminals SW1 and SW7 outside the power supply IC 2. The capacitor C2 is connected to the terminals SW2 and SW6, and the capacitor C3 is connected to the terminals SW3 and SW7.

The gate driver 21 is connected to the terminals BST1 and SW1 and the gate of the power transistor M1, and the gate driver 21 generates and outputs the gate G1 according to the voltage between the terminals BST1 and SW1. The gate driver 22 is connected to the terminals BST2 and SW2 and the gate of the power transistor M2, and the gate driver 22 generates and outputs the gate G2 according to the voltage between the terminals BST2 and SW2. The gate driver 23 is connected to the terminals BST3 and SW3 and the gate of the power transistor M3, and the gate driver 23 generates and outputs the gate G3 according to the voltage between the terminals BST3 and SW3. The gate driver 26 is connected to the terminals BST6 and SW6 and the gate of the power transistor M6, and the gate driver 26 generates and outputs the gate G6 according to the voltage between the terminals BST6 and SW6. The gate driver 27 is connected to the terminals BST7 and SW7 and the gate of the power transistor M7, and the gate driver 27 generates and outputs the gate G7 according to the voltage between the terminals BST7 and SW7.

The gate driver 24 is connected to the terminals BST4 and OUT and the gate of the power transistor M4, and the gate driver 24 generates and outputs the gate G4 according to the voltage between the terminals BST4 and OUT. The gate driver 25 is connected to a terminal that receives an internal power supply voltage VREG, the terminal PGND, and the gate of the power transistor M5, and the gate driver 25 generates and outputs the gate G5 according to the internal power supply voltage VREG with respect to the ground potential. The gate driver 28 is connected to a terminal that receives the internal power supply voltage VREG, the terminal PGND, and the gate of the power transistor M8, and the gate driver 28 generates and outputs the gate G8 according to the internal power supply voltage VREG with respect to the ground potential.

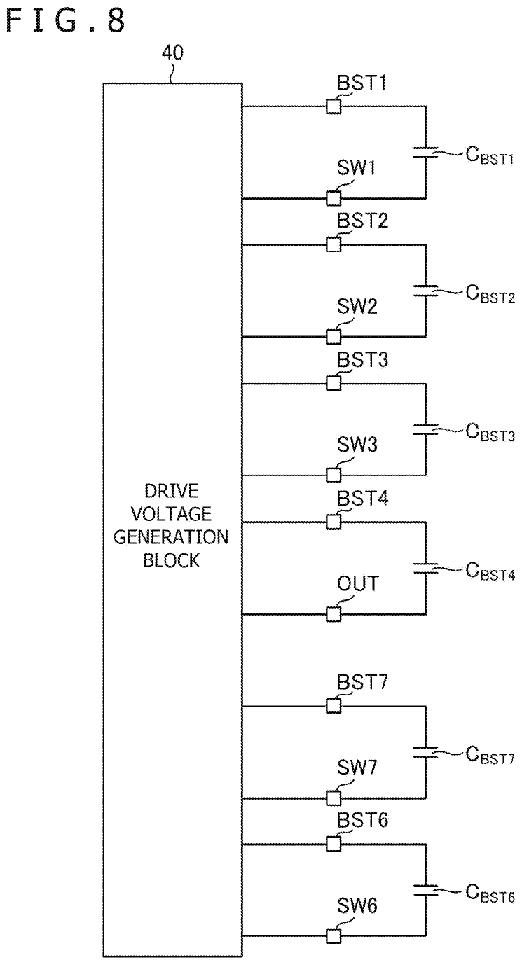

As illustrated in FIG. 8, the drive voltage generation block 40 is connected to the terminals BST1 to BST4, BST6, BST7, SW1 to SW3, SW6, SW7, and OUT. The drive voltage generation block 40 forms a bootstrap circuit along with the capacitors CBST1 to CBST4, CBST6, and CBST7 to thereby generate the drive voltages (voltages for driving the power transistors M1 to M8) described above. The bootstrap circuit belongs to a well-known technique, and the detailed circuit configuration and operation inside the bootstrap circuit will not be described.

The drive voltages include a first boot voltage that is a voltage of the terminal BST1 with respect to the potential of the terminal SW1, a second boot voltage that is a voltage of the terminal BST2 with respect to the potential of the terminal SW2, a third boot voltage that is a voltage of the terminal BST3 with respect to the potential of the terminal SW3, a fourth boot voltage that is a voltage of the terminal BST4 with respect to the potential of the terminal OUT, a sixth boot voltage that is a voltage of the terminal BST6 with respect to the potential of the terminal SW6, and a seventh boot voltage that is a voltage of the terminal BST7 with respect to the potential of the terminal SW7. It is considered here that the drive voltages further include the internal power supply voltage VREG Note that the internal power supply voltage VREG is a positive DC voltage generated according to the input voltage V_{IN} or the output voltage V_{OUT}.

The first, second, third, fourth, sixth, and seventh boot voltages are larger than the gate threshold voltages of the power transistors M1, M2, M3, M4, M6, and M7, respectively. The internal power supply voltage VREG is larger than the gate threshold voltages of the power transistors M5 and M8. The gate threshold voltage of each power transistor has a positive voltage value (for example, 0.5 V).

Each of the gate signals G1 to G8 has a signal level that is one of the high level and the low level. The gate signals G1, G2, G3, G4, G6, and G7 in the high level have the potentials of the terminals BST1, BST2, BST3, BST4, BST6, and BST7, respectively. The gate signals G1, G2, G3, G4, G6, and G7 in the low level have the potentials of the terminals SW1, SW2, SW3, OUT, SW6, and SW7, respectively. The gate signals G5 and G8 in the high level have the potential of the internal power supply voltage VREG The gate signals G5 and G8 in the low level have the ground potential.

Therefore, the power transistors M1, M2, M3, M4, M5, M6, M7, and M8 are in the on-state when the gate signals G1, G2, G3, G4, G5, G6, G7, and G8 are in the high level, respectively. The power transistors M1, M2, M3, M4, M5, M6, M7, and M8 are in the off-state when the gate signals G1, G2, G3, G4, G5, G6, G7, and G8 are in the low level, respectively.

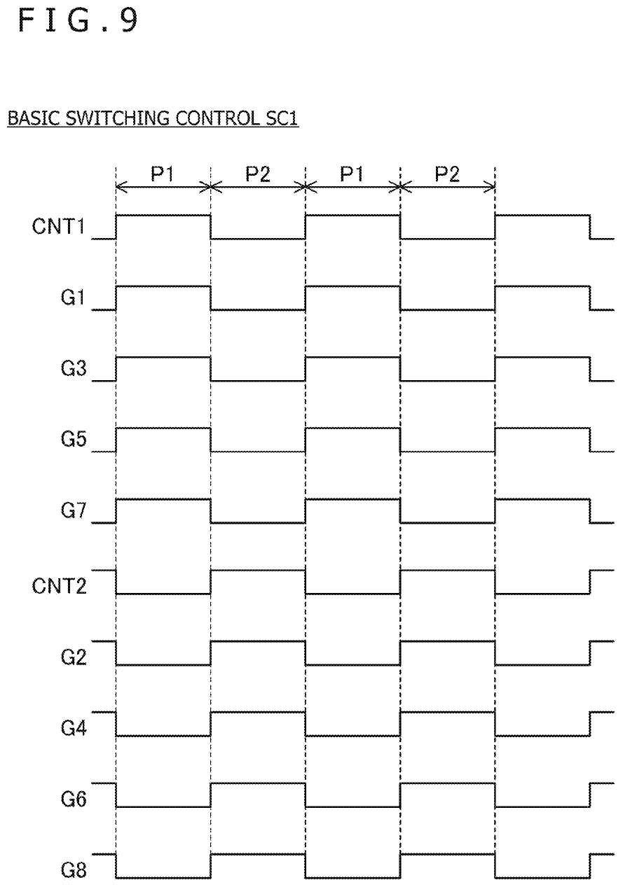

FIG. 9 illustrates a timing chart of basic switching control SC1. The power supply IC 2 may be able to execute the basic switching control SC1. It can be understood that the basic switching control SC1 is realized by cooperation of the control block 10 and the drive block 20 in this case. In the basic switching control SC1, the control block 10 generates control signals CNT1 and CNT2 as the control signals CNT (see FIG. 6) and outputs the control signals CNT1 and CNT2 to the drive block 20. In the basic switching control SC1, the control signals CNT1 and CNT2 are square wave signals with a frequency f_{SW} in which the signal level is alternately switched to the high level and the low level. The frequency f_{SW} corresponds to a switching frequency of the power transistors M1 to M8.

That is, the control signal CNT1 is alternately switched to the high level and the low level in the basic switching control SC1, and the length of the high level period of the control signal CNT1 and the length of the low level period of the control signal CNT1 in one cycle of the control signal CNT1 are equal to each other. Therefore, the duty of the control signal CNT1 is 50%. The reciprocal of one cycle of the control signal CNT1 is the frequency f_{SW}. In the basic switching control SC1, the control signal CNT2 is also alternately switched to the high level and the low level. Here, the phase of the control signal CNT1 and the phase of the control signal CNT2 are shifted from each other by 180 degrees. Therefore, the control signal CNT2 is in the low level when the control signal CNT1 is in the high level, and the control signal CNT2 is in the high level when the control signal CNT1 is in the low level in the basic switching control SC1. The period in which the control signal CNT1 is in the high level and the control signal CNT2 is in the low level will be referred to as a period P1, and the period in which the control signal CNT1 is in the low level and the control signal CNT2 is in the high level will be referred to as a period P2. The periods P1 and P2 alternately and repeatedly come in the basic switching control SC1, and the repetition frequency of the periods P1 and P2 is the frequency f_{SW}.

In the basic switching control SC1, the control signal CNT1 functions as a control signal for the gate drivers 21, 23, 25, and 27, and the control signal CNT2 functions as a control signal for the gate drivers 22, 24, 26, and 28.

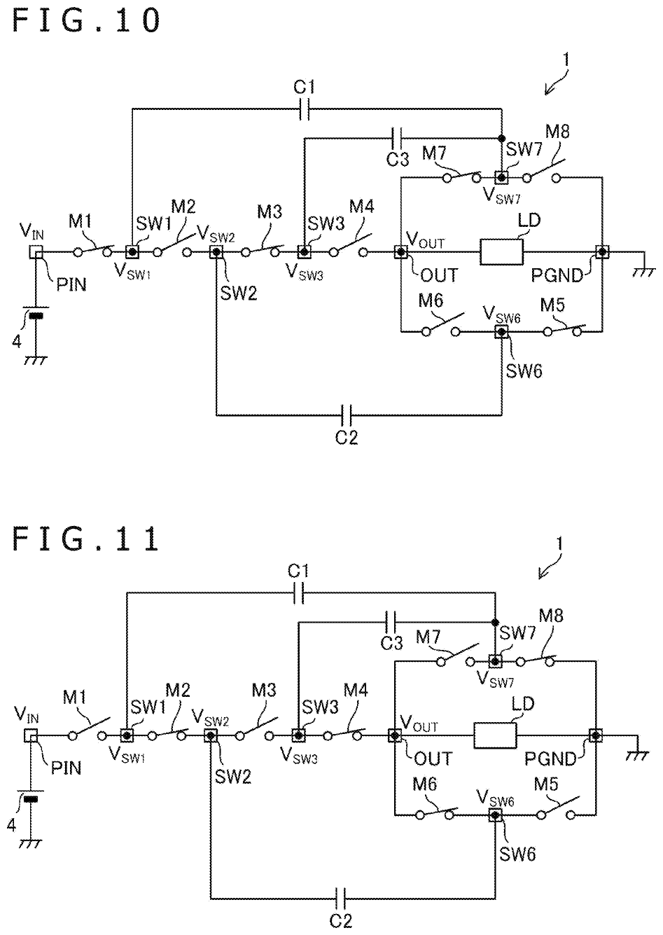

In the period P1, the gate drivers 21, 23, 25, and 27 supply the gate signals G1, G3, G5, and G7 in the high level to the gates of the power transistors M1, M3, M5, and M7, respectively, according to the control signal CNT1 in the high level. In the period P1, the gate drivers 22, 24, 26, and 28 supply the gate signals G2, G4, G6, and G8 in the low level to the gates of the power transistors M2, M4, M6, and M8, respectively, according to the control signal CNT2 in the low level. Therefore, in the period P1 of the basic switching control SC1, the power transistors M1, M3, M5, and M7 are controlled in the on-state, and the power transistors M2, M4, M6, and M8 are controlled in the off-state as illustrated in FIG. 10.

In the period P2, the gate drivers 21, 23, 25, and 27 supply the gate signals G1, G3, G5, and G7 in the low level to the gates of the power transistors M1, M3, M5, and M7, respectively, according to the control signal CNT1 in the low level. In the period P2, the gate drivers 22, 24, 26, and 28 supply the gate signals G2, G4, G6, and G8 in the high level to the gates of the power transistors M2, M4, M6, and M8, respectively, according to the control signal CNT2 in the high level. Therefore, in the period P2 of the basic switching control SC1, the power transistors M1, M3, M5, and M7 are controlled in the off-state, and the power transistors M2, M4, M6, and M8 are controlled in the on-state as illustrated in FIG. 11.

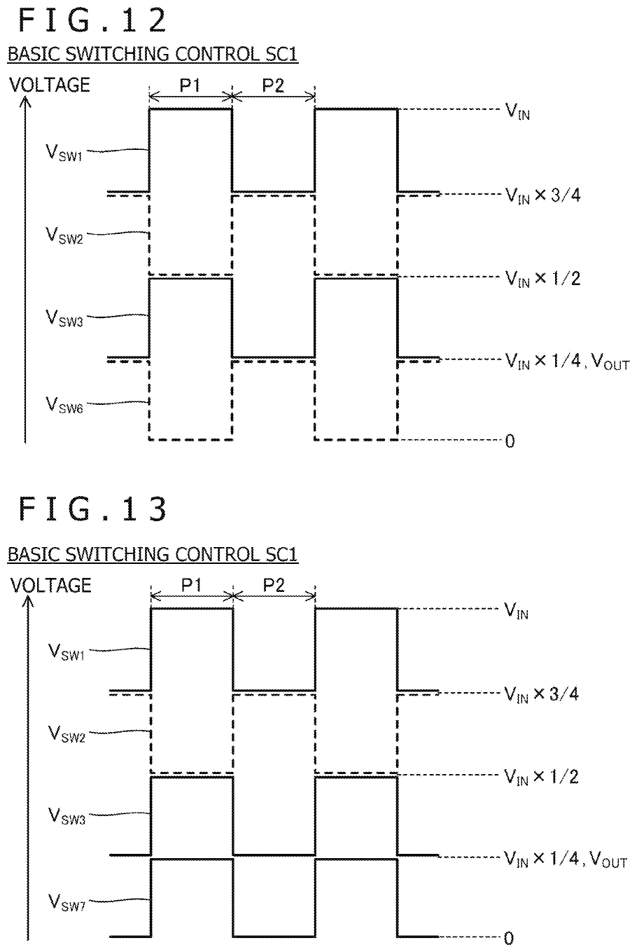

FIGS. 12 and 13 illustrate voltage waveforms of the terminals in the basic switching control SC1. In FIG. 12, square-wave solid-line waveforms represent the waveforms of the voltages V_{SW1} and V_{SW3} in the basic switching control SC1, and square-wave dashed-line waveforms represent the waveforms of the voltages V_{SW2} and V_{SW6} in the basic switching control SC1. In FIG. 13, square-wave solid-line waveforms represent the waveforms of the voltages V_{SW1}, V_{SW3}, and V_{SW7} in the basic switching control SC1, and a square-wave dashed-line waveform represents the waveform of the voltage V_{SW2} in the basic switching control SC1. FIGS. 12 and 13 illustrate the terminal voltages after stabilization of the output voltage V_{OUT} of the SCC 1. The output voltage V_{OUT} substantially coincides with a voltage (V_{IN}×¼) after the stabilization of the output voltage V_{OUT} of the SCC 1.

In the period P1 of the basic switching control SC1, the voltage V_{SW1} substantially coincides with the input voltage V_{IN}, and the voltages V_{SW2} and V_{SW3} substantially coincide with a voltage (V_{IN}×½). The voltage V_{SW6} substantially coincides with 0 V, and the voltage V_{SW7} substantially coincides with the voltage (V_{IN}×¼). In the period P2 of the basic switching control SC1, the voltages V_{SW1} and V_{SW2} substantially coincide with a voltage (V_{IN}×¾), and the voltages V_{SW3} and V_{SW6} substantially coincide with the voltage (V_{IN}×¼). The voltage V_{SW7} substantially coincides with 0 V.

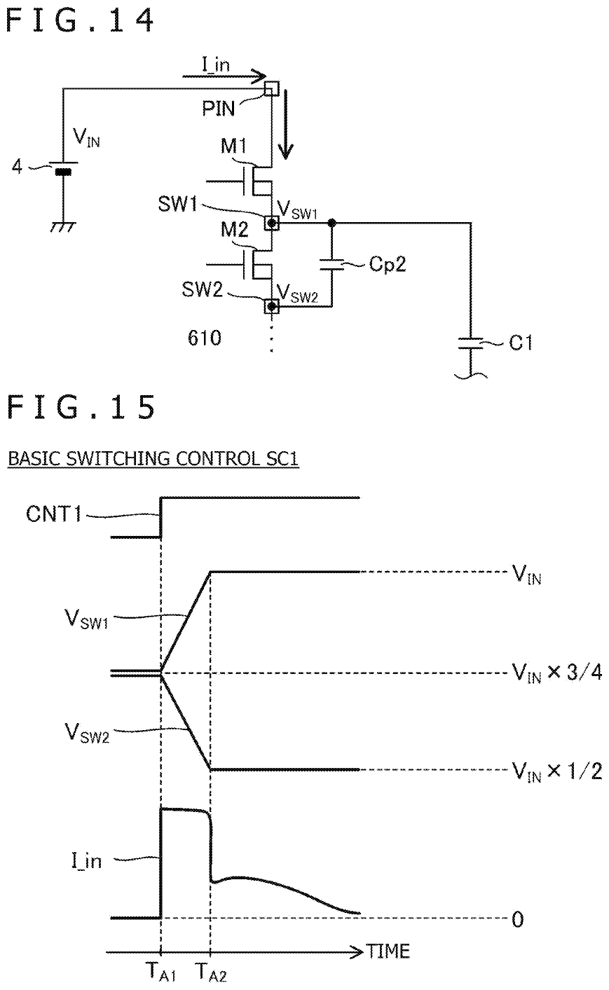

A flow of current in the basic switching control SC1 will be described with reference to FIGS. 14 and 15. A current supplied from the voltage source 4 to the terminal P_{IN} will be referred to as an input current I_in. The input current I_in flows toward the terminal SW1 through the channel of the power transistor M1 when the power transistor M1 is ON. In FIG. 14, Cp2 represents parasitic capacitance added to the power transistor M2. The parasitic capacitance Cp2 is added to between the drain and the source of the power transistor M2.

FIG. 15 illustrates signal waveforms around time T_{A1} at which there is an up edge in the control signal CNT1 in the basic switching control SC1. FIG. 15 illustrates waveforms of the control signal CNT1, the voltage V_{SW1}, the voltage V_{SW2}, and the input current I_in from top to bottom. In the basic switching control SC1, the power transistors M1, M3, M5, and M7 are turned on and the power transistors M2, M4, M6, and M8 are turned off at the same time in synchronization with the up edge of the control signal CNT1 at time T_{A1}.

When the power transistor M1 is turned on in synchronization with the up edge of the control signal CNT1 at time T_{A1}, the voltage V_{SW1} rises from the voltage (V_{IN}×¾) toward the input voltage V_{IN} from time T_{A1} to time T_{A2}. When the power transistor M2 is turned off in synchronization with the up edge of the control signal CNT1 (in other words, the down edge of the control signal CNT2) at time T_{A1}, the voltage V_{SW2} drops from the voltage (V_{IN}×¾) toward the voltage (V_{IN}×½) from time T_{A1} to time T_{A2} Therefore, the parasitic capacitance Cp2 is charged by the amount of voltage (V_{IN}×½) between time T_{A1} and time T_{A2}, and the current necessary for the charge is included in the input current I_in. That is, the input current I_in charges the parasitic capacitance Cp2 by the amount of voltage (V_{IN}×½) between time T_{A1} and time T_{A2}.

The rise in the voltage V_{SW1} and the drop in the voltage V_{SW2} starting at time T_{A1} are completed at time T_{A2}. After time T_{A2}, the input current I_in flows toward the capacitor C1, and the input current I_in is used to charge the capacitor C1. The input current I_in after time T_{A2} is a current for moving the charge to the terminal OUT. The current is fundamentally necessary to stabilize the output voltage V_{OUT} at a desirable voltage, and the current varies according to the current consumption of the load LD.

The charge current to the parasitic capacitance Cp2 between time T_{A1} and time T_{A2} is fairly large, and relatively large noise (radiation noise) is generated by the flow of the charge current to the parasitic capacitance Cp2 through an input wire. The input wire denotes a wire connecting the voltage source 4 and the terminal PIN. A flow of a high-frequency large current through the input wire leads to an increase in the noise. The influence of noise is also increased when the distance between the voltage source 4 and the terminal PIN is long and the input wire is long.

Revised switching control SC2 will be proposed as switching control that contributes to the reduction of noise. The plurality of switch elements (M1 to M8) provided on the SCC 1 include a first switch element group in which ON and OFF are controlled according to the control signal CNT1, and a second switch element group in which ON and OFF are controlled according to the control signal CNT2. In other words, each of the switch elements (M1 to M8) provided on the SCC 1 belongs to any one of the first switch element group in which ON and OFF are controlled according to the control signal CNT1 and the second switch element in which ON and OFF are controlled according to the control signal CNT2. Specifically, the switch elements M1, M3, M5, and M7 belong to the first switch element group, and the switch elements M2, M4, M6, and M8 belong to the second switch element group. In other words, the first switch element group includes the switch elements M1, M3, M5, and M7, and the second switch element group includes the switch elements M2, M4, M6, and M8.

In the revised switching control SC2, the turn-on timing of the switch element M1 is set to be later than the turn-on timings of the switch elements M3, M5, and M7 in turning on the switch elements belonging to the first switch element group according to the control signal CNT1. Other than this, the revised switching control SC2 may be similar to the basic switching control SC1. The switch element M1 is an example of a target switch element, and the switch elements M3, M5, and M7 are examples of non-target switch elements.

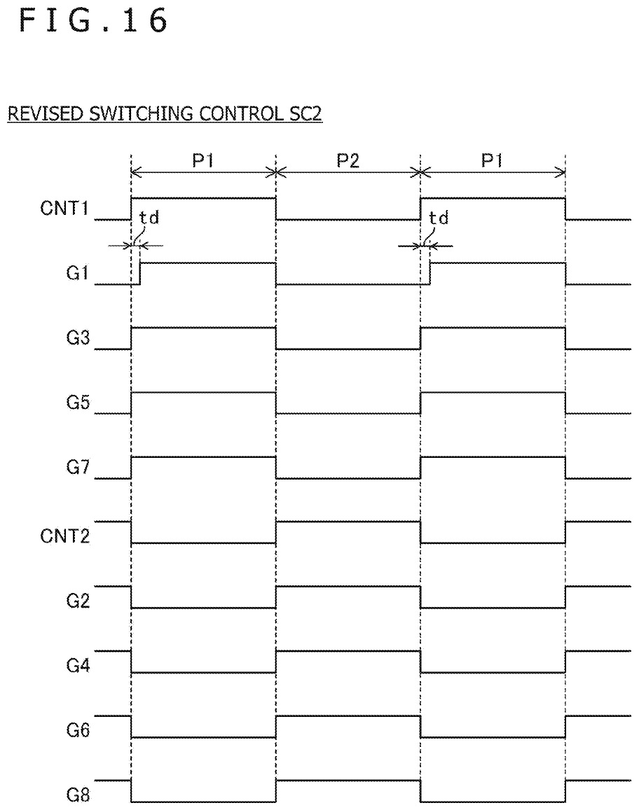

FIG. 16 illustrates a timing chart of the revised switching control SC2. The power supply IC 2 according to the present disclosure actually executes the revised switching control SC2 instead of the basic switching control SC1. It can be understood that the revised switching control SC2 is realized by cooperation of the control block 10 and the drive block 20. Note that the power supply IC 2 may be configured to selectively execute the basic switching control SC1 or the revised switching control SC2. In the revised switching control SC2, the control block 10 generates the control signals CNT1 and CNT2 as the control signals CNT (see FIG. 6) and outputs the control signals CNT1 and CNT2 to the drive block 20. The control signals CNT1 and CNT2 in the revised switching control SC2 are the same as the control signals CNT1 and CNT2 in the basic switching control SC1. Therefore, in the revised switching control SC2, the control signals CNT1 and CNT2 are square wave signals with the frequency f_{SW} in which the signal level is alternately switched to the high level and the low level. The phase of the control signal CNT1 and the phase of the control signal CNT2 are shifted from each other by 180 degrees. The frequency f_{SW} corresponds to the switching frequency of the power transistors M1 to M8.

As described above, the period in which the control signal CNT1 is in the high level and the control signal CNT2 is in the low level will be referred to as the period P1, and the period in which the control signal CNT1 is in the low level and the control signal CNT2 is in the high level will be referred to as the period P2. As in the basic switching control SC1, the periods P1 and P2 alternately and repeatedly come in the revised switching control SC2, and the repetition frequency of the periods P1 and P2 is the frequency f_{SW}.

The up edge timing of the control signal CNT1 and the down edge timing of the control signal CNT2 are the same, and the down edge timing of the control signal CNT1 and the up edge timing of the control signal CNT2 are the same. Therefore, the revised switching control SC2 will be described with a focus on the up edge timing and the down edge timing of the control signal CNT1.

In the revised switching control SC2, the up edges are generated in the gate signals G3, G5, and G7 in synchronization with the up edge of the control signal CNT1 to turn on the power transistors M3, M5, and M7 at the same time, and the down edges are generated in the gate signals G2, G4, G6, and G8 in synchronization with the up edge of the control signal CNT1 (in other words, in synchronization with the down edge of the control signal CNT2) to turn off the power transistors M2, M4, M6, and M8 at the same time.

In the revised switching control SC2, the up edge is generated in the gate signal G1 at the timing after the delay time td from the up edge timing of the control signal CNT1 to thereby turn on the power transistor M1.

Therefore, the period P1 of the revised switching control SC2 includes a former period in which the power transistors M3, M5, and M7 are ON and the power transistors M1, M2, M4, M6, and M8 are OFF, and a latter period in which the power transistors M1, M3, M5, and M7 are ON and the power transistors M2, M4, M6, and M8 are OFF. The latter period comes after the former period equivalent to the delay time td. The delay time td is sufficiently shorter than the period P1, and for example, the delay time td is time equivalent to approximately one degree of the phase of the control signal CNT1.

In the revised switching control SC2, the down edges are generated in the gate signals G1, G3, G5, and G7 in synchronization with the down edge of the control signal CNT1 to turn off the power transistors M1, M3, M5, and M7 at the same time, and the up edges are generated in the gate signals G2, G4, G6, and G8 in synchronization with the down edge of the control signal CNT1 (in other words, in synchronization with the up edge of the control signal CNT2) to turn on the power transistors M2, M4, M6, and M8 at the same time.

Therefore, the power transistors M1, M3, M5, and M7 are OFF, and the power transistors M2, M4, M6, and M8 are ON in the period P2 of the revised switching control SC2, as in the period P2 of the basic switching control SC1.

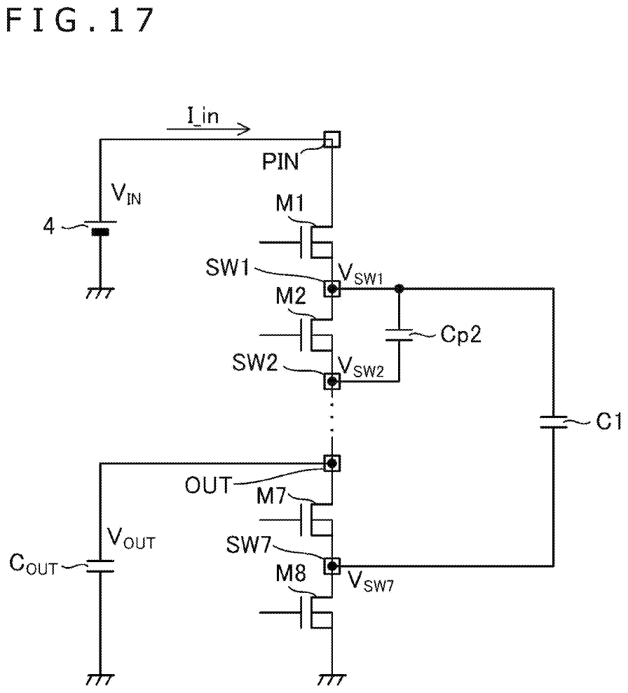

FIG. 17 illustrates a circuit diagram of a part particularly related to the operation of the revised switching control SC2 in the circuit of the SCC 1. Although not illustrated in FIGS. 1, 2, and the like, an output capacitor C_{OUT} is provided between the terminal OUT and the ground in the SCC 1. That is, one end of the output capacitor C_{OUT} is connected to the terminal OUT, and the other end of the output capacitor C_{OUT} is connected to the ground (therefore, the terminal PGND). The output voltage V_{OUT} is applied to between both ends of the output capacitor C_{OUT}.

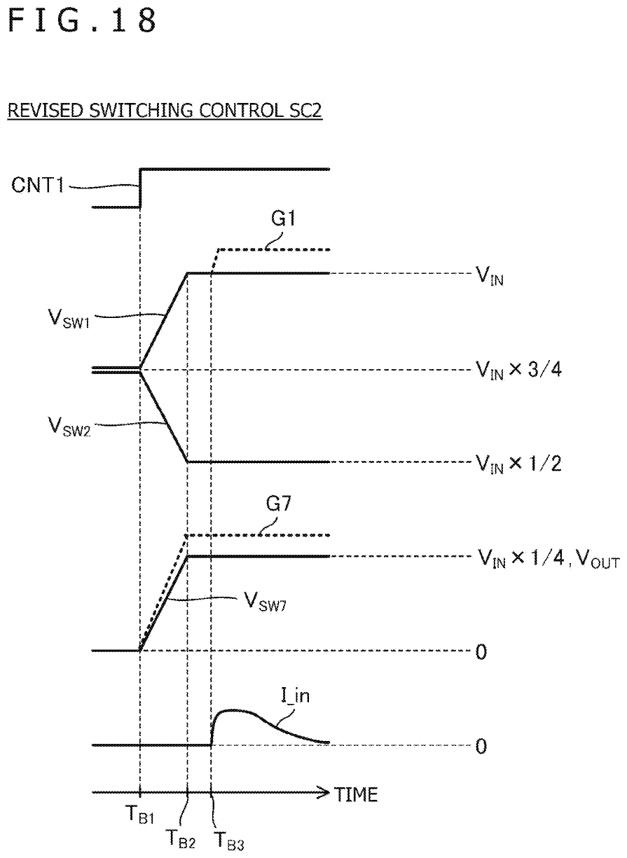

FIG. 18 illustrates signal waveforms around time T_{B1} at which there is an up edge in the control signal CNT1 in the revised switching control SC2. FIG. 18 illustrates solid-line waveforms indicating the waveforms of the control signal CNT1, the voltage V_{SW1}, the voltage V_{SW2}, the voltage V_{SW7}, and the input current I_in from top to bottom. FIG. 18 further illustrates dashed-line waveforms indicating the waveforms of the gate signals G1 and G7. In the timing chart of FIG. 18, the level of the gate signal G1 coincides with the level of the voltage V_{SW1} until time T_{B3} described later, and the waveform of the voltage V_{SW1} and the waveform of the gate signal G1 overlap with each other (the overlap is not apparent in FIG. 18). In the timing chart of FIG. 18, the level of the gate signal G7 coincides with the level of the voltage V_{SW7} until time T_{B1}, and the waveform of the voltage V_{SW7} and the waveform of the gate signal G7 overlap with each other (the overlap is not apparent in FIG. 18).

There is an up edge in the control signal CNT1 at time T_{B1}. The gate signals G3, G5, and G7 rise from the low level toward the high level to turn on the power transistors M3, M5, and M7 in synchronization with the up edge of the control signal CNT1 at time T_{B1}, and the power transistors M3, M5, and M7 are turned on in the course of the rise. The gate signals G2, G4, G6, and G8 drop from the high level toward the low level to turn off the power transistors M2, M4, M6, and M8 in synchronization with the up edge of the control signal CNT1 at time T_{B1} (in other words, in synchronization with the down edge of the control signal CNT2), and the power transistors M2, M4, M6, and M8 are turned off in the course of the drop.

When the power transistor M7 is turned on and the power transistor M8 is turned off in synchronization with the up edge of the control signal CNT1 at time T_{B1}, the voltage V_{SW7} rises from 0 V toward the output voltage V_{OUT}. When the power transistor M2 is turned off and the power transistor M3 is turned on in synchronization with the up edge of the control signal CNT1 at time T_{B1}, the voltage V_{SW2} drops from the voltage (V_{IN}×¾) toward the voltage (V_{IN}×½). Time T_{B2} after time T_{B1} represents the time at which the rise in the voltage V_{SW7} to the output voltage V_{OUT} and the drop in the voltage V_{SW2} to the voltage (V_{IN}×½) are completed. Note that the output voltage V_{OUT} corresponds to the voltage (V_{IN}×¼) as described above (see FIG. 13 and the like).

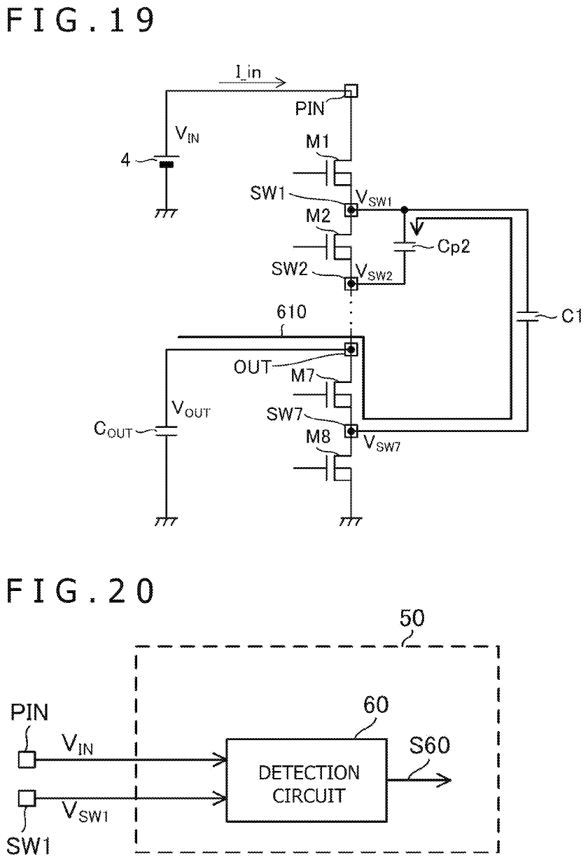

Due to the up edge of the control signal CNT1 at time T_{B1}, the power transistor M2 is turned off, and the voltage V_{SW7} rises by the amount of voltage (V_{IN}×¼). The rise in the voltage V_{SW7} raises the voltage V_{SW1} of the terminal SW1 through the capacitor C1. The power transistor M1 is in the off-state at this point. Therefore, the charge for raising the voltage V_{SW1} is supplied from the output capacitor C_{OUT} toward the terminal SW1 through the terminal OUT, the channel of the power transistor M7, and the capacitor C1 and is used to charge the parasitic capacitance Cp2 as indicated by a polygonal line 610 in FIG. 19. The voltage V_{SW1} reaches the input voltage V_{IN} at time T_{B2} in conjunction with the rise in the voltage V_{SW7}.

The gate signal G1 is in the low level at time T_{B2}, and the low level of the gate signal G1 coincides with the voltage V_{SW1} of the terminal SW1. At time T_{B3} after time T_{B2}, the drive block 20 raises the gate signal G1 from the low level to the high level. Although the rise requires a given time, it is considered here that there is an up edge in the gate signal G1 at time T_{B3} and the power transistor M1 is turned on at time T_{B3}. Therefore, the time from time T_{B1} to time T_{B3} corresponds to the delay time td described above. The input current I_in after time T_{B3} is a current for moving the charge to the terminal OUT and is a current fundamentally necessary to stabilize the output voltage V_{OUT} at a desirable voltage. The input current I_in varies according to the current consumption of the load LD.

The parasitic capacitance Cp2 is fully charged at the point of time T_{B3}. Therefore, unlike in the basic switching control SC1, the input current I_in for charging the parasitic capacitance Cp2 (corresponding to the input current I_in between time T_{A1} and time T_{A2} in FIG. 15) does not flow or is suppressed in the revised switching control SC2. As a result, the amount of generating noise can be reduced compared to the basic switching control SC1.

Note that the output voltage V_{OUT} of the SCC 1 is a voltage to be supplied to the load LD. Therefore, the load LD is arranged near the terminal OUT and the output capacitor Coin, and the wire (hereinafter, referred to as an output wire) connecting the load LD to the terminal OUT and the output capacitor Coin is short. On the other hand, the wire (input wire) between the voltage source 4 and the SCC 1 may be long depending on the shape and the like of the apparatus provided with the voltage source 4, the SCC 1, and the load LD. That is, the input wire is often longer than the output wire. Therefore, it is important to suppress the noise generated in the input wire, and the amount of radiation noise from the input wire is actually emphasized or evaluated in a standard test of the apparatus. In addition, an input capacitor (not illustrated) that receives the input voltage V_{IN} may be provided near the terminal P_{IN}. However, the input voltage V_{IN} is relatively high, and the capacitance of the input capacitor is often smaller than the capacitance of the output capacitor C_{OUT}. Therefore, the supply of the charge current to the parasitic capacitance Cp2 through the output wire instead of the input wire is advantageous for suppressing the noise.

Hereinafter, some specific operation examples, applied techniques, modified techniques, and the like related to the SCC 1 among a plurality of examples will be described. The items described in the embodiment are applied to the following examples unless otherwise stated, as long as there is no contradiction. The description in the examples may be prioritized when there are items in the examples inconsistent with the items described above. The items described in any example among the plurality of examples illustrated below can also be applied to any other examples (that is, any two or more examples among the plurality of examples can be combined).

### First Example

A first example will be described. The control drive circuit 50 (see FIG. 6) according to the example of FIG. 18 turns on the power transistors M3, M5, and M7 and turns off the power transistors M2, M4, M6, and M8 in synchronization with the up edge of the control signal CNT1. The control drive circuit 50 turns on the power transistor M1 after the voltage V_{SW1} at the terminal SW1 rises to the input voltage V_{IN}.

However, the control drive circuit 50 (see FIG. 6) may turn on the power transistor M1 in the course of the rise in the voltage V_{SW1} at the terminal SW1 to the input voltage V_{IN} after turning on the power transistors M3, M5, and M7 and turning off the power transistors M2, M4, M6, and M8 in synchronization with the up edge of the control signal CNT1. In this case, the drive block 20 starts to raise the gate signal G1 from the low level to the high level to turn on the power transistor M1 after time T_{B1}, before time T_{B2}. As a result, the input current I_in for charging the parasitic capacitance Cp2 is also smaller than in the basic switching control SC1, and the amount of noise is reduced.

### Second Example

A second example will be described. The delay time td of the second example is a time set in advance (that is, predetermined time). More specifically, the control drive circuit 50 of the second example turns on the power transistors M3, M5, and M7 and turns off the power transistors M2, M4, M6, and M8 in synchronization with the up edge of the control signal CNT1. The control drive circuit 50 turns on the power transistor M1 after the delay time td, which is a predetermined time, after the up edge timing of the control signal CNT1.

By appropriately setting the delay time td, the control drive circuit 50 of the second example can turn on the power transistor M1 when the voltage V_{SW1} rises to the input voltage V_{IN}, after turning on the power transistors M3, M5, and M7 and turning off the power transistors M2, M4, M6, and M8 in synchronization with the up edge of the control signal CNT1.

The time necessary for the voltage V_{SW1} to reach the input voltage V_{IN} after time T_{B1} can be evaluated in, for example, the design stage of the power supply IC 2 or the SCC 1, and the delay time td can be set according to the evaluation result. In this case, it is preferable to set the delay time td such that the power transistor M1 is turned on as quickly as possible after the voltage V_{SW1} reaches the input voltage V_{IN} in order to, for example, improve the efficiency of the SCC 1.

However, even when the delay time td is set to turn on the power transistor M1 after the voltage V_{SW1} reaches the input voltage V_{IN}, the delay time td may be shorter than the time necessary for the voltage V_{SW1} to reach the input voltage V_{IN} depending on the characteristic variations of the parts or the ambient temperature of the SCC 1. As a result, in some cases, the control drive circuit 50 of the second example turns on the power transistor M1 in the course of the rise in the voltage V_{SW1} at the terminal SW1 to the input voltage V_{IN} after turning on the power transistors M3, M5, and M7 and turning off the power transistors M2, M4, M6, and M8 in synchronization with the up edge of the control signal CNT1.

### Third Example

A third example will be described. Whether the rise in the voltage V_{SW1} to the input voltage V_{IN} is completed may be detected after the power transistors M3, M5, and M7 are turned on and the power transistors M2, M4, M6, and M8 are turned off in synchronization with the up edge of the control signal CNT1. A detection circuit 60 for the detection may be provided on the control drive circuit 50 (see FIG. 20).

The detection circuit 60 is connected to the terminals P_{IN} and SW1 and receives the input voltage V_{IN} and the voltage V_{SW1}. The detection circuit 60 compares the size of the difference between the input voltage V_{IN} and the voltage V_{SW1} (|V_{IN}−V_{SW1}|) with a predetermined small threshold th. The detection circuit 60 outputs a signal S60 with a value of “0” if the former is larger than the latter (th) and outputs a signal S60 with a value of “1” if the former is smaller than the latter (th). A switch in the value of the signal S60 from “0” to “1” indicates that the rise in the voltage V_{SW1} to the input voltage V_{IN} is completed (indicates that the completion is detected).

When the value of the signal S60 is switched from “0” to “1” after the control drive circuit 50 of the third example turns on the power transistors M3, M5, and M7 and turns off the power transistors M2, M4, M6, and M8 in synchronization with the up edge of the control signal CNT1, the control drive circuit 50 determines that the rise in the voltage V_{SW1} to the input voltage V_{IN} is completed and turns on the power transistor M1 (that is, turns on the power transistor M1 after the detection of the completion).

### Fourth Example

A fourth example will be described. Modified techniques and the like of the items described above will be described in the fourth example.

The relation between the high level and the low level of a freely selected signal or voltage may be opposite the relation described above as long as the objective is not lost.

The types of the channels of the FETs (field-effect transistors) illustrated in the embodiment are illustrative. The type of the channel of a freely selected FET may be changed between the P channel and the N channel as long as the objective is not lost. For example, the power transistors M1 to M8 may include P-channel MOSFETs.

A freely selected transistor described above may be a freely selected type of transistor as long as there is no inconvenience. For example, a freely selected transistor described above that is a MOSFET may be replaced with a junction FET, an IGBT (Insulated Gate Bipolar Transistor), or a bipolar transistor as long as there is no inconvenience. The freely selected transistor includes a first electrode, a second electrode, and a control electrode. In the FET, one of the first and second electrodes is the drain, and the other is the source. The control electrode is the gate. In the IGBT, one of the first and second electrodes is the collector, and the other is the emitter. The control electrode is the gate. In a bipolar transistor not belonging to the IGBT, one of the first and second electrodes is the collector, and the other is the emitter. The control electrode is the base.

In the example illustrated in the embodiment, the SCC includes eight switch elements (M1 to M8) and three flying capacitors (01 to C3) connected in the connection relation of FIG. 1. However, as is well known, the number of switch elements, the number of flying capacitors, and the connection relation between the plurality of switch elements and the plurality of flying capacitors in the SCC may vary, and the technique of the present disclosure is not limited to the one described above. It is only sufficient that the switching circuit including the plurality of switch elements and the plurality of flying capacitors be connected to the input terminal that receives the input voltage (V_{IN}) and the output terminal that receives the output voltage (V_{OUT}), and the plurality of switch elements and the plurality of flying capacitors be connected to each other such that the output voltage (V_{OUT}) is generated from the input voltage (V_{IN}) by turning on and off the plurality of switch elements according to a predetermined pattern.

The embodiment of the present disclosure can be appropriately changed in various ways within the scope of the technical ideas indicated in the claims. The embodiment described above is just an example of the embodiment of the present disclosure, and the meaning of the terms in the present disclosure and the constituent elements is not limited to the meaning described in the foregoing embodiment. The specific values illustrated in the description are illustrative only, and the values can be obviously changed to various values.

### <<Supplement>>

The following is a supplement of the present disclosure for which the specific configuration example is illustrated in the embodiment.

A mode of the present disclosure provides a power supply semiconductor device (2) used in a switched capacitor converter (1) including a plurality of switch elements (M1 to M8) and a plurality of capacitors (01 to C3), the switched capacitor converter configured to turn on and off the plurality of switch elements according to a predetermined pattern to generate an output voltage (V_{OUT}) from an input voltage (V_{IN}), the power supply semiconductor device including a control drive circuit (50) configured to generate a control signal (CNT1) for designating ON or OFF of each of the switch elements and turn on or off each of the switch elements according to the control signal, in which the plurality of switch elements include: a first switch element group (M1, M3, M5, and M7) in which ON and OFF are controlled according to the control signal (CNT1); and a second switch element group (M2, M4, M6, and M8) in which ON and OFF are controlled according to a signal (CNT2) with a phase shifted by 180 degrees from a phase of the control signal, the first switch element group includes: a target switch element (M1) configured to receive the input voltage; and non-target switch elements (M3, M5, and M7), and the control drive circuit sets turn-on timing of the target switch element (M1) to be later than turn-on timing of the non-target switch elements (M3, M5, and M7) in turning on each of the switch elements belonging to the first switch element group according to the control signal (first configuration).

In this way, the charge current to the parasitic capacitance connected to the target switch element can be supplied through the non-target switch elements before the target switch element is turned on. That is, the supply of the charge current to the parasitic capacitance connected to the target switch element through the target switch element is suppressed. This suppresses the noise (radiation noise) caused by the charge current flowing through the wire (input wire) that receives the input voltage.

In the power supply semiconductor device according to the first configuration, the control signal may be in a first level or a second level, the control drive circuit may turn on the non-target switch elements (M3, M5, and M5) and turn off the switch elements (M2, M4, M6, and M8) in the second switch element group in synchronization with a change in the control signal from the first level to the second level and then turn on the target switch element (M1), and the control drive circuit may turn off the target switch element and the non-target switch elements and turn on the switch elements in the second switch element group in synchronization with a change in the control signal from the second level to the first level (second configuration).

Although the first level and the second level correspond to, for example, the high level and the low level, respectively, the relation between them may be the opposite.

In the power supply semiconductor device according to the second configuration, the target switch element (M1) may be connected to an input terminal (PIN), which receives the input voltage, and a first terminal (SW1), the target switch element may electrically connect or cut off the input terminal and the first terminal, the non-target switch elements of the first switch element group may include a first specific switch element (M7) connected to an output terminal (OUT), which receives the output voltage, and a second terminal (SW7), the first specific switch element configured to electrically connect or cut off the output terminal and the second terminal, the second switch element group may include: a second specific switch element (M2) connected to the first terminal (SW1) and a third terminal (SW2), the second specific switch element configured to electrically connect or cut off the first terminal and the third terminal; and a third specific switch element (M8) connected to the second terminal (SW7) and a fourth terminal (PGND) with a potential lower than the output voltage, the third specific switch element configured to electrically connect or cut off the second terminal and the fourth terminal, and the plurality of capacitors may include a target capacitor (C1) provided between the first terminal and the second terminal (third configuration).

Thus, the charge current to the parasitic capacitance added to the second specific switch element can be supplied from the output terminal through the first specific switch element and the target capacitor before the target switch element is turned on. That is, the supply of the charge current to the parasitic capacitance through the target switch element is suppressed. This suppresses the noise (radiation noise) caused by the charge current flowing through the wire (input wire) that receives the input voltage.

Although the fourth terminal described above corresponds to the terminal PGND in the foregoing embodiment, the fourth terminal may be a freely selected terminal with a potential lower than the output voltage.

In the power supply semiconductor device according to the third configuration (see FIGS. 18 and 19), when the control drive circuit turns on the non-target switch elements and turns off the switch elements in the second switch element group in synchronization with the change in the control signal from the first level to the second level, a voltage (V_{SW7}) of the second terminal may rise toward the output voltage, and the rise in the voltage of the second terminal may raise a voltage (V_{SW1}) of the first terminal toward the input voltage through the target capacitor (C1), and the control drive circuit may turn on the target switch element after the voltage of the first terminal rises to the input voltage or turn on the target switch element in the course of the rise in the voltage of the first terminal to the input voltage (fourth configuration).

This suppresses the noise (radiation noise) caused by the charge current flowing through the wire (input wire) that receives the input voltage.

In the power supply semiconductor device according to any one of the second to fourth configurations, the control drive circuit may turn on the non-target switch elements and turn off the switch elements in the second switch element group in synchronization with the change in the control signal from the first level to the second level and may turn on the target switch element after a predetermined time after the change in the control signal from the first level to the second level (fifth configuration).

By appropriately setting the predetermined time, the target switch element can be turned on after the rise in the voltage of the first terminal to the input voltage, for example.

In the power supply semiconductor device according to the fourth configuration, the control drive circuit may detect whether the rise in the voltage of the first terminal to the input voltage is completed after turning on the non-target switch elements and turning off the switch elements in the second switch element group in synchronization with the change in the control signal from the first level to the second level and may turn on the target switch element after the detection of the completion (sixth configuration).

This can certainly ensure the sequence of turning on the target switch element after the rise in the voltage of the first terminal to the input voltage.

The power supply semiconductor device according to any one of the first to sixth configurations may further include: an input terminal (PIN) configured to receive the input terminal; and an output terminal (OUT) configured to receive the output voltage, in which a switching circuit including the plurality of switch elements and the plurality of capacitors is connected to the input terminal and the output terminal, and the plurality of switch elements and the plurality of capacitors are connected to each other such that the output voltage is generated from the input voltage by turning on and off the plurality of switch elements according to the predetermined pattern (seventh configuration).

A mode of the present disclosure provides a switched capacitor converter including: the power supply semiconductor device according to any one of the first to seventh configurations including a plurality of power transistors; and a plurality of capacitors (eighth configuration).

According to the present disclosure, the power supply semiconductor device and the switched capacitor converter that contribute to the suppression of noise can be provided.

What is claimed is:

1. A power supply semiconductor device used in a switched capacitor converter including a plurality of switch elements and a plurality of capacitors, the switched capacitor converter configured to turn on and off the plurality of switch elements according to a predetermined pattern to generate an output voltage from an input voltage, the power supply semiconductor device comprising:
a control drive circuit configured to generate a control signal for designating ON or OFF of each of the switch elements and turn on or off each of the switch elements according to the control signal, wherein
the plurality of switch elements include
a first switch element group in which ON and OFF are controlled according to the control signal, and
a second switch element group in which ON and OFF are controlled according to a signal with a phase shifted by 180 degrees from a phase of the control signal,
the first switch element group includes
a target switch element configured to receive the input voltage, and non-target switch elements, and
the control drive circuit sets turn-on timing of the target switch element to be later than turn-on timing of the non-target switch elements in turning on each of the switch elements belonging to the first switch element group according to the control signal.

2. The power supply semiconductor device according to claim 1, wherein
the control signal is in a first level or a second level,
the control drive circuit turns on the non-target switch elements and turns off the switch elements in the second switch element group in synchronization with a change in the control signal from the first level to the second level and then turns on the target switch element, and
the control drive circuit turns off the target switch element and the non-target switch elements and turns on the switch elements in the second switch element group in synchronization with a change in the control signal from the second level to the first level.

3. The power supply semiconductor device according to claim 2, wherein
the target switch element is connected to an input terminal, which receives the input voltage, and a first terminal, and the target switch element electrically connects or cuts off the input terminal and the first terminal,
the non-target switch elements of the first switch element group include a first specific switch element connected to an output terminal, which receives the output voltage, and a second terminal, the first specific switch element being configured to electrically connect or cut off the output terminal and the second terminal,
the second switch element group include a second specific switch element connected to the first terminal and a third terminal, the second specific switch element configured to electrically connect or cut off the first terminal and the third terminal; and a third specific switch element connected to the second terminal and a fourth terminal with a potential lower than the output voltage, the third specific switch element being configured to electrically connect or cut off the second terminal and the fourth terminal, and
the plurality of capacitors include a target capacitor provided between the first terminal and the second terminal.

4. The power supply semiconductor device according to claim 3, wherein,
when the control drive circuit turns on the non-target switch elements and turns off the switch elements in the second switch element group in synchronization with the change in the control signal from the first level to the second level, a voltage of the second terminal rises toward the output voltage, and the rise in the voltage of the second terminal raises a voltage of the first terminal toward the input voltage through the target capacitor, and
the control drive circuit turns on the target switch element after the voltage of the first terminal rises to the input voltage or turns on the target switch element in the course of the rise in the voltage of the first terminal to the input voltage.

5. The power supply semiconductor device according to claim 2, wherein
the control drive circuit turns on the non-target switch elements and turns off the switch elements in the second switch element group in synchronization with the change in the control signal from the first level to the second level and turns on the target switch element after a predetermined time after the change in the control signal from the first level to the second level.

6. The power supply semiconductor device according to claim 4, wherein
the control drive circuit detects whether the rise in the voltage of the first terminal to the input voltage is completed after turning on the non-target switch elements and turning off the switch elements in the second switch element group in synchronization with the change in the control signal from the first level to the second level and turns on the target switch element after the detection of the completion.

7. The power supply semiconductor device according to claim 1, further comprising:
an input terminal configured to receive the input terminal; and
an output terminal configured to receive the output voltage, wherein
a switching circuit including the plurality of switch elements and the plurality of capacitors is connected to the input terminal and the output terminal, and the plurality of switch elements and the plurality of capacitors are connected to each other such that the output voltage is generated from the input voltage by turning on and off the plurality of switch elements according to the predetermined pattern.

8. A switched capacitor converter comprising:
the power supply semiconductor device according to claim 1 including a plurality of switch elements; and
a plurality of capacitors.
